(19) United States
(12) Patent Application Publication
(10) Pub. No.: US 2004/0214481 A1
(43) Pub. Date: Oct. 28, 2004

(54) Mounting structure of receiving box for refrigerator

(75) Inventor: Yong-Chol Kwon, Changwon City (KR)

Correspondence Address: FLESHNER & KIM, LLP, P.O. BOX 221200, CHANTILLY, VA, 20153, US

(73) Assignee: LG Electronics Inc.

(21) Appl. No.: 10/829,208

(22) Filed: Apr. 22, 2004

(30) Foreign Application Priority Data
Apr. 23, 2003 (KR) 2003-0025866

(51) Int. Cl. H01R 13/62

(52) U.S. Cl. 439/894

(57) ABSTRACT

The invention relates to a mounting structure of a receiving box for a refrigerator. The mounting structure comprises a receiving chamber cover 35 for defining a separately partitioned space 33 in a storage space 31 formed within a main body 30 of the refrigerator; a receiving box 40 or 40′ installed in the partitioned space 33 defined by the receiving chamber cover 35 and having a receiving space 45 that is open at an upper face thereof for storing stuffs therein; guide rails 37 formed at positions on the receiving chamber cover 35 corresponding to inner sides of both sidewalls of the receiving box 40 or 40′ so as to extend in a direction in which the receiving box 40 or 40′ is pushed into and taken out from the partitioned space; and guide flanges 41 formed to be located in the coverage of the receiving space 45 at upper ends of the both sidewalls of the receiving box 40 or 40′ corresponding to the guide rails 37 so as to be supported and guided by the guide rails 37. According to the present invention, the storage space 45 of the receiving box 40 or 40′ can be maximized, and a good appearance of a portion where a front surface of the receiving box 40 or 40′ is exhibited can be ensured.

### BACKGROUND OF THE INVENTION

1. Field of the Invention

The present invention relates to a refrigerator, and more particularly, to a receiving box for forming a space that is defined by separately partitioning a storage space in a refrigerator to store stuffs therein.

2. Description of the Prior Art

A receiving box for a refrigerator forms a space separately partitioned within a storage space in the refrigerator in order to store stuffs. A typical one of such receiving boxes is a vegetable box that is to store stuffs such as vegetables or fruits therein. An essential structure of a refrigerator with such a receiving box mounted therein is shown in FIG. 4.

As shown in the figure, a storage space is formed within a main body 10 of the refrigerator 10, and an inner case 11 forms an inner surface defining the storage space. A receiving chamber cover 15 is horizontally installed to partition the storage space in an up and down direction. With the receiving chamber cover 15, a separately partitioned space 13 is formed.

Guide rails 17 are formed at the center and both sides of a bottom surface of the receiving chamber cover 15. Each guide rail 17 extends in a fore and aft direction while protruding vertically from the bottom surface of the receiving chamber cover 15. Guide channels 19 are defined along the respective guide rails 17, and guide flanges 21 of vegetable boxes 20 and 20′ to be described later are inserted into and guided by the guide channels 19. Specifically, the guide rail 17 formed at the center of the bottom surface of the receiving chamber cover 15 defines one guide channel 19 at each of opposite sides thereof.

A pair of receiving boxes 20 and 20′ can be pushed into and taken out from the partitioned space 13 in a drawer manner. Each of the receiving boxes 20 and 20′ is provided with a receiving space 25 with an open upper face. Various kinds of stuffs such as vegetables or fruits can be stored in the receiving space 25. When the receiving boxes 20 and 20′ are accommodated in the partitioned space 13, they are shielded by the receiving chamber cover 15.

The guide flanges 21 that will be guided by and along the guide rails 17 are provided at upper ends of both sidewalls of each of the receiving boxes 20 and 20′. The guide flanges 21 extend in a fore and aft direction of each of the receiving boxes 20 and 20′. The guide flanges 21 are inserted into the guide channels 19 defined by the guide rails 17. The guide flanges 21 are formed to protrude laterally from the both sidewalls of each of the receiving boxes 20 and 20′.

However, the conventional receiving box for a refrigerator constructed as above has the following problems.

In the conventional receiving box 20 or 20′, the guide flanges 21 for guidance of the movement of the receiving box are formed to protrude laterally from the both sidewalls of the receiving box. Therefore, spaces below the guide flanges 21 outside the receiving boxes 20 and 20′ (hatched areas A in FIG. 4) become unavailable spaces.

That is, in order to allow the guide flanges 21 to be guided by the guide rails 17, regions below the guide flanges 21 should remain empty spaces. Consequently, the dimensions of the receiving boxes 20 and 20′ to be accommodated within the limited partitioned space 13 should be decreased. Accordingly, there is a problem in that the sizes of the receiving spaces 25 defined by the receiving boxes 20 and 20′ are relatively decreased.

Further, due to spaces defined between an inner wall of the partitioned space 13 and each of the receiving boxes 20 and 20′ and between the receiving boxes 20 and 20′, there is another problem in that a front appearance of the partitioned space 13 in which the receiving boxes 20 and 20′ will be accommodated is deteriorated.

### SUMMARY OF THE INVENTION

Accordingly, the present invention is contemplated to solve the aforementioned problems in the prior art. An object of the present invention is to provide a mounting structure of a receiving box for a refrigerator, which can maximize the volume of the receiving box provided in the refrigerator.

Another object of the present invention is to provide a mounting structure of a receiving box for a refrigerator, which ensures a good front appearance of a portion of the refrigerator in which the receiving box will be accommodated.

According to the present invention for achieving the objects, there is provided a mounting structure of a receiving box for a refrigerator comprises a receiving chamber cover for defining a separately partitioned space in a storage space formed within a main body of the refrigerator; a receiving box installed in the partitioned space defined by the receiving chamber cover and having a receiving space that is open at an upper face thereof for storing stuffs therein; guide rails formed at positions on the receiving chamber cover corresponding to inner sides of both sidewalls of the receiving box so as to extend in a direction in which the receiving box is pushed into and taken out from the partitioned space; and guide flanges formed to be located in the coverage of the receiving space at upper ends of the both sidewalls of the receiving box corresponding to the guide rails so as to be supported and guided by the guide rails.

The guide rails and the guide flanges may extend in a direction such that they can correspond to each other, and the guide rails may define longitudinally extending guide channels. The guide flanges can be inserted into and guided by the guide channels.

The guide flanges may be formed such that leading ends thereof protrude by a predetermined length inwardly with respect to the both sidewalls of the receiving box so as to face each other.

One or more receiving box may be provided, and one of the guide rails may be provided on each of the both side ends of each receiving box.

Leading ends of the guide flanges may protrude by a predetermined length to face outwardly with respect to the both sidewalls of the receiving box but be positioned inside of the both sidewalls.

One or more receiving boxes may be provided, a common guide rail may be provided at a position where the receiving boxes are adjacent to each other, and the common guide rail may define channels on opposite sides thereof.

The guide flanges may be provided at leading ends of connection portions formed at the upper ends of the both sidewalls of the receiving box and in the coverage of the receiving space.

The guide flanges may at least partially extend from rear ends of the both sidewalls of the receiving box toward front ends of the sidewalls.

With the mounting structure of a receiving box for a refrigerator according to the present invention constructed as above, there are advantages in that an inner space of the receiving box and availability of the installation space of the receiving box can be maximized, and a relatively good front appearance of the receiving box can be ensured.

### BRIEF DESCRIPTION OF THE DRAWINGS

The above and other objects and features of the present invention will become apparent from the following description of preferred embodiments given in conjunction with the accompanying drawings, in which:

FIG. 1 is a sectional view showing a mounting structure of a receiving box for a refrigerator according to a preferred embodiment of the present invention;

FIG. 2 is a perspective view schematically showing the receiving box according to the embodiment shown in FIG. 1;

FIG. 3 is a sectional view showing a mounting structure of a receiving box according to another embodiment of the present invention; and

FIG. 4 is a sectional view showing a conventional mounting structure of a receiving box for a refrigerator.

### DESCRIPTION OF THE PREFERRED EMBODIMENTS

Hereinafter, preferred embodiments of a mounting structure of a receiving box for a refrigerator according to the present invention will be described in detail with reference to the accompanying drawings.

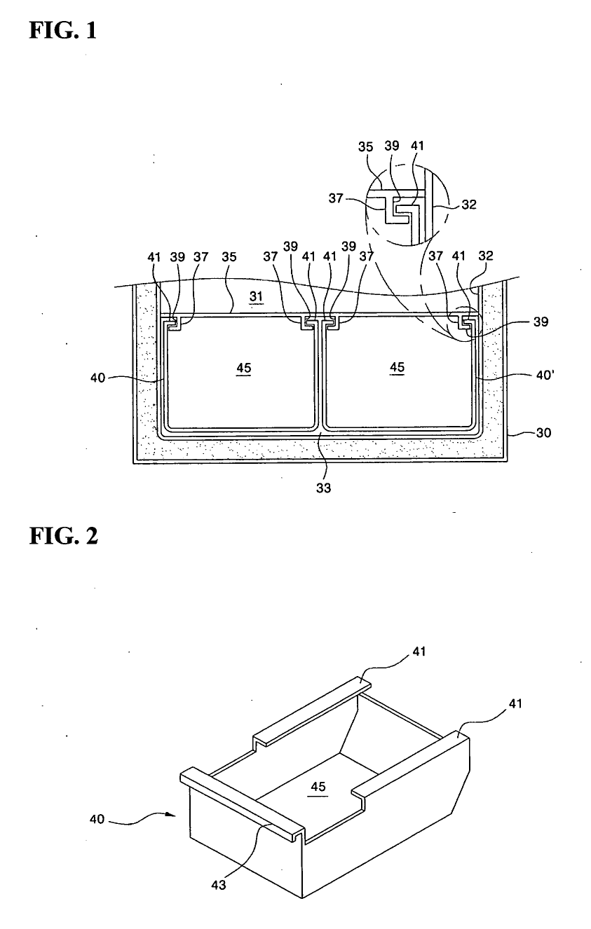

FIG. 1 is a sectional view showing a mounting structure of a receiving box for a refrigerator according to a preferred embodiment of the present invention, and FIG. 2 schematically shows the receiving box according to the embodiment shown in FIG. 1.

As shown in the figures, a storage space 31 is formed within a main body 30 of a refrigerator. An inner case 32 forms an inner wall defining the storage space 31. A receiving chamber cover 35 partitions the storage space 31, which is defined by the inner case 32, at a lower portion thereof to define a separate partitioned space 33. The receiving chamber cover 35 is supported by the inner case 32 that forms both sidewalls defining the storage space 31. For the sake of convenience of illustration, a structure of the inner case 32 for supporting the receiving chamber cover 35 is omitted.

Guide rails 37 are provided on a bottom surface of the receiving chamber cover 35. The guide rails 37 are provided at positions corresponding to both side ends of each of receiving boxes 40 and 40′ to be accommodated in the partitioned space 33. The guide rails 37 extend from a front end to a rear end of the receiving chamber cover 35.

Guide channels 39 are defined by the guide rails 37. The guide channels 39 extend along the guide rails 37. Guide flanges 41 of the receiving boxes 40 and 40′, which will be described later, are inserted into and supported by the guide channels 39. To this end, in the present embodiment, the guide channels 39 defined by the guide rails 37 for the respective receiving boxes 40 and 40′ should be formed to be open in opposite directions. Accordingly, in a case where a pair of receiving boxes 40 and 40′ are provided, the guide rails 37 are provided at 4 locations in total.

The receiving boxes 40 and 40′ are provided in the partitioned space 33. An example of the structure of the receiving box 40 or 40′ is shown in FIG. 2. The receiving box 40 or 40′ has a structure conforming to the shape of the partitioned space 33 and generally takes the shape of a hexahedron. The receiving boxes 40 and 40′ are installed in the partitioned space 33 so as to be pushed into and taken out from the partitioned space in a drawer manner.

To this end, the guide flanges 41 are formed at the both side ends of each of the receiving boxes 40 and 40′. The guide flanges 41 are formed to protrude by a stuffs in or from the receiving space.

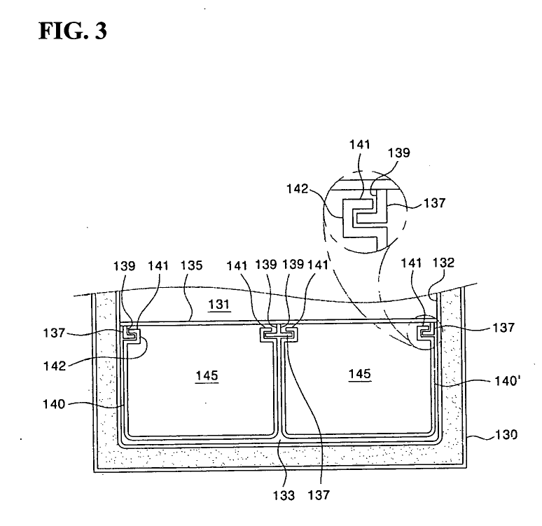

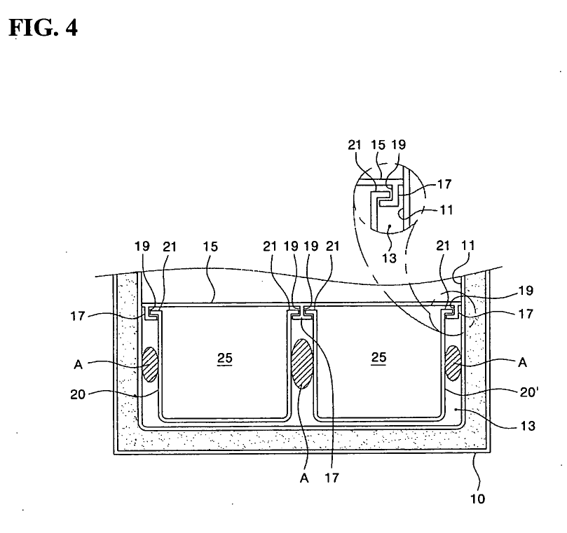

Meanwhile, FIG. 3 shows another embodiment of the present invention. In this figure, for the sake of convenience of explanation, like elements corresponding to those of the previous embodiment are designated by reference numerals increased by 100. As shown in the figure, guide flanges 141 are formed at upper ends of both sidewalls of each of receiving boxes 140 and 140′. The guide flanges 141 do not also protrude outwardly beyond the both sidewalls of each of the receiving boxes 140 and 140′ but remain in the coverage of the receiving space 145.

In the present embodiment, leading ends of the guide flanges 141 extend outwardly with respect to the both sidewalls of each of the receiving boxes 140 and 140′. To this end, the guide flange 141 and the upper end of each sidewall of each of the receiving boxes 140 and 140′ are connected by a connection portion 142. The connection portion 142 extends by a predetermined length toward the receiving space 145 of each of the receiving boxes 140 and 140′ at the upper end of each sidewall, and is then bent substantially vertically upward and further extends by a predetermined length. The guide flange 141 is provided at a leading end of the connection portion 142 that extends vertically upward. The leading end of the guide flange 141 should be formed not to protrude outwardly beyond the sidewall.

Meanwhile, since the leading ends of the guide flanges 141 formed in each of the receiving boxes 140 and 140′ face outward with respect to the both sidewalls in the present embodiment, the guide rail 137 placed at a position where the receiving boxes 140 and 140′ come into contact with each other can be shared by the receiving boxes 140 and 140′. That is, the guide channels 139 can be formed at opposite sides of the guide rail 137 to support and guide the relevant guide flanges 141 of the receiving boxes 140 and 140′.

Now, the operation of the mounting structure of the receiving box for the refrigerator according to the present invention constructed as above will be described in detail.

The receiving boxes 40 and 40′ are installed to be pushed or taken out in a drawer manner into or from the partitioned space 33 separately defined by the receiving chamber cover 35 within the storage space 31. That is, the guide flanges 41 of the receiving boxes 40 and 40′ are inserted into and supported by the guide channels 39 of the guide rails 37 to guide the movement of the receiving boxes.

With such a structure, when a user holds and pulls the handle 43 of either of the receiving boxes 40 and 40′, the relevant receiving box 40 or 40′ is taken out. At this time, the guide flanges 41 of the receiving box 40 or 40′ are guided while being supported by the guide channels 39 of the guide rails 37.

When the receiving box 40 or 40′ is taken out from the partitioned space 33, the upper face of the receiving space 45 becomes open so that the user can put or pick up stuffs in or from the receiving space. When the stuffs have been completely put in or picked up from the receiving box 40 or 40′ and the user then holds and pushes the handle 43 of the receiving box 40 or 40′, the receiving box 40 or 40′ is accommodated in the partitioned space 33. Then, the upper face of the receiving space 45 of the receiving box 40 or 40′, i.e. the entrance of the receiving space, is shielded by the receiving chamber cover 35 from the outside. Accordingly, since the receiving space 45 is in a shielded state against the outside, the stored stuffs can be preserved fresher.

Meanwhile, as can be seen in FIG. 1, there is no waste of space between the receiving boxes 40 and 40′ and between the respective receiving boxes 40 and 40′ and the inner case 32. That is, the partitioned space 33 can be more efficiently used. Accordingly, the volumes of the receiving spaces 45 of the receiving boxes 40 and 40′ can be maximized.

Of course, it is also preferred that necessary gaps be provided between the receiving boxes 40 and 40′ and between the respective receiving boxes 40 and 40′ and the inner case 32 to facilitate the flow of cold air or the movement of the receiving boxes 40 and 40′. However, with the use of the present invention, the volumes of the receiving spaces 45 of the receiving boxes 40 and 40′ can be maximized even in this case.

It will be apparent to those skilled in the art that other various modifications may be made within the scope of this basic technical spirit of the present invention. The scope of the present invention should be interpreted on the basis of the appended claims.

Although the present invention has been described only in connection with a case where a pair of receiving boxes are mounted, it is not limited thereto. That is, the present predetermined length from and perpendicularly to sidewalls of the receiving boxes 40 and 40′. The guide flanges 41 are inserted into the guide channels 39 defined by the guide rails 37 to support the receiving boxes 40 and 40′ and simultaneously guide the movement thereof.

Accordingly, the guide flanges 41 extend in a fore and aft direction of the receiving boxes 40 and 40′. Of course, the guide flanges 41 are not necessarily formed throughout an entire length between front and rear ends of each of the receiving boxes 40 and 40′. That is, it is sufficient to form the guide flanges over only regions required for supporting the receiving boxes 40 and 40′ below the receiving chamber cover 35 and allowing the movement of the receiving boxes 40 and 40′. Further, each guide flange 41 is not necessarily formed integrally but may be constructed of a plurality of separate pieces.

The guide flanges 41 are formed to be located inside the both sidewalls of each of the receiving boxes 40 and 40′. That is, the guide flanges 41 are formed not to protrude outwardly beyond the sidewalls of the receiving boxes 40 and 40′. With such a structure, the interior of each of the receiving boxes 40 and 40′ has a cross sectional area larger than that of an open upper face thereof, when viewed in a plan view.

As shown in FIG. 2, the guide flanges 41 are not formed throughout the entire lengths of the both sidewalls of the receiving box 40 or 40′. It is preferred that the guide flanges 41 be provided to be relatively offset toward the rear end of the receiving box 40 or 40′. With such a structure, the receiving box 40 or 40′ can be taken out maximally from the partitioned space 33.

A grip 43 is provided at a front surface of the receiving box 40 or 40′. The grip 43 is a portion that is held by a user and subjected to a force exerted by the user when the user pushes or takes out the receiving box 40 or 40′. The position or shape of the handle 43 may vary in addition to that shown in the figure.

A receiving space 45 is defined in the receiving box 40 or 40′. The receiving space 45 has an open upper face, and the upper face of the receiving space 45 is shielded by the receiving chamber cover 35 when the receiving box 40 or 40′ is accommodated in the partitioned space 33. Of course, when the receiving box 40 or 40′ is taken out from the partitioned space 33, the receiving space 45 is open so that a user can put or pick up invention can also be applied to a case where a single receiving box, or three or more receiving boxes are mounted.

As described above, in the mounting structure of the receiving box for the refrigerator according to the present invention, the guide rails, the guide flanges and the like which are used for the movement of the receiving box are provided in the coverage of the receiving space of the receiving box.

Accordingly, the volume of the receiving box installed in the partitioned space separately defined within the storage space of the refrigerator can be maximized, thereby relatively improving the efficiency of reception of stuffs.

In addition, since unnecessary spaces cannot be produced between the respective receiving boxes and between the receiving box and the inner case, there is an advantage in that a good front appearance of a portion where front surfaces of the receiving boxes are exhibited can be ensured.

What is claimed is:

1. A mounting structure of a receiving box for a refrigerator, comprising:
a receiving chamber cover for defining a separately partitioned space in a storage space formed within a main body of the refrigerator;
a receiving box installed in the partitioned space and having a receiving space for storing stuffs therein, the receiving space being open at an upper face thereof;
guide rails formed at positions on the receiving chamber cover corresponding to inner sides of both sidewalls of the receiving box so as to extend in a direction in which the receiving box is pushed into and taken out from the partitioned space; and
guide flanges formed to be located in the coverage of the receiving space at upper ends of the both sidewalls of the receiving box corresponding to the guide rails so as to be supported and guided by the guide rails.

2. The mounting structure as claimed in claim 1, wherein the guide rails and the guide flanges extend in a direction such that they can correspond to each other, and the guide rails define longitudinally extending guide channels, the guide flanges being inserted into and guided by the guide channels.

3. The mounting structure as claimed in claim 2, wherein the guide flanges are formed such that leading ends thereof protrude by a predetermined length inwardly with respect to the both sidewalls of the receiving box so as to face each other.

4. The mounting structure as claimed in claim 3, wherein one or more receiving box are provided, and one of the guide rails is provided on each of the both side ends of each receiving box.

5. The mounting structure as claimed in claim 2, wherein leading ends of the guide flanges protrude by a predetermined length to face outwardly with respect to the both sidewalls of the receiving box but are positioned inside of the both sidewalls.

6. The mounting structure as claimed in claim 5, wherein one or more receiving boxes are provided, a common guide rail is provided at a position where the receiving boxes are adjacent to each other, and the common guide rail defines channels on opposite sides thereof.

7. The mounting structure as claimed in claim 5, wherein the guide flanges are provided at leading ends of connection portions formed at the upper ends of the both sidewalls of the receiving box and in the coverage of the receiving space.

8. The mounting structure as claimed in claim 1, wherein the guide flanges at least partially extend from rear ends of the both sidewalls of the receiving box toward front ends of the sidewalls.
